(19) United States
(12) Patent Application Publication
(10) Pub. No.: US 2011/0102362 A1
(43) Pub. Date: May 5, 2011

(54) Writing and displaying device

(76) Inventors: Huang-Sheng Fang, Hsinchu (TW); Yi-Wen Chung, Hsinchu (TW); Chih-Jen Tsai, Hsinchu (TW)

(21) Appl. No.: 12/657,452

(22) Filed: Jan. 21, 2010

(30) Foreign Application Priority Data
Nov. 5, 2009 (TW) 98133668

(51) Int. Cl. G06F 3/045

(52) U.S. Cl. 345/174

(57) ABSTRACT

A writing and displaying device is proposed, including: a display member having a first electric connecting portion and an electrochromic layer; an input member including a second electric connecting portion and an electrolyte layer; and a power supply member for supplying electric power to the input member and the display member. When the electric power is supplied by the power supply member and the input member is in contact with the display member, the input member, the display member and the power supply member constitute a loop circuit such that an electrochromism occurs to the portion of the display member in contact with the input member. The electrochromism can be maintained for a predetermined duration of time even after the contact of the display member with the input member is removed and the driving power is turned off.

### BACKGROUND OF THE INVENTION

1. Field of the Invention

The present invention relates generally to writing and displaying devices, and more particularly to an electrochromic writing and displaying device.

2. Description of Related Art

A conventional writing and displaying device, such as a writing board, comprises a resistive writing board, a capacitive writing board, and an electromagnetic writing board. The resistive writing board is made up of two layers of resistive thin films, wherein the resistive thin film of the upper layer can slightly deform and the resistive thin film of the lower layer is fixed. A stylus pen is used to contact and press against the resistive thin film of the upper layer such that the resistive thin film of the upper layer is in contact with the resistive thin film of the lower layer, thereby determining the writing position and recognizing the input information. In a capacitive writing board, a capacitive panel is used to replace the resistive panel. Both the resistive writing board and capacitive writing board require considerable forces to be exerted by the user and have short lifetime. A conventional electromagnetic writing board has a loop circuit board disposed on surface thereof such that when the electric power is supplied, a magnetic field is generated within a certain range above the writing board. Meanwhile, a corresponding magnetic field is formed on the tip of a stylus pen. As such, even if the tip of the stylus pen is not in contact with the writing board, it can be positioned through sensing of the magnetic field. When the tip of the stylus pen is in contact with or close to the surface of the writing board, an character recognition is automatically performed by software in order to achieve a prescribed effect of using handwriting input. As a result, the above-described writing boards all require software for character recognition and have problem in sensitivity, and thus are not so convenience in use.

Electrochromism denotes a color-changing phenomenon of material resulted from an oxidation-reduction reaction while a voltage is applied. The electrochromism is usually applied to glass windows, vehicle rearview mirrors and displays. FIG. 1 shows the most common structure of a conventional electrochromic member. Referring to FIG. 1, the electrochromic member 1 mainly comprises an upper conductive substrate 11, a lower conductive substrate 14, an electrochromic layer 12 and an electrolyte layer 13 sandwiched between the upper and lower conductive substrates 11, 14. The conventional electrochromic member 1 can be applied to image display devices such as electronic clocks and electronic tags; however, they are only limited to the a passive display. That is, information must be input through an external device such as a keyboard before it can be displayed through an electrochromic device. Therefore, such a device cannot be applied as a writing and displaying device.

Taiwan Patent No. 200846803 discloses an electrochromic display device with a contact control function, wherein when the contact control portion is pressed, the electric power is supplied such that the electrochromatic display portion changes color and enables the corresponding control function of the contact control portion. Therefore, the input operation of the touch control portion can be performed according to the display message of the electrochromic display portion. The electrochromic display device has a conventional sandwich structure, and the patterns or messages displayed on the electrochromic layer need to be pre-designed on the electrochromic layer instead of being directly written, input and displayed. Therefore, such a structure is mainly applied to portable devices with button-type control portions for controlling the electrochromic display.

U.S. Pat. No. 6,441,942 discloses an optical writing type electrochromic display that uses a photoconductive material as a medium such that when an electric field is applied across the electrochromic material and the photoconductive material, light of certain wavelength incident onto the photoconductive material causes the photoconductive material to conduct current locally, thereby enabling the electrochromic material to change color. When a reversal electric field is applied, the electrochromic material turns back to the original color. Therefore, the effect of displaying and deleting the writing information is achieved. The patent implements a non-contact writing mode for input. Nevertheless, it requires the use of the photoconductive material and light of certain wavelength, thereby complicating the structure and limiting its application.

U.S. Pat. No. 4,205,903 discloses an electrochromic display with its display cell of a sandwich structure forming into a separate electrocromic pixel, wherein the electrochromism is controlled by switching on and off an electric field. An electroplated insulating layer is used to define desired patterns to be displayed on electrodes, and a liquid electrochromic material is disposed between the electrodes and packaged to form a single display cell. In electrochroming, the area covered by the insulating layer does not change color but the area that is not covered by the insulating layer changes color such that a desired pattern is displayed. Nevertheless, the device does not support real-time and random writing.

U.S. Pat. Nos. 3,987,433 and 4,246,579 disclose methods for controlling well-designed electrochromic display pixels through circuits, which also do not support real-time and random writing.

Therefore, the above-described conventional electrochromic display devices are only limited to passive display and cannot be applied as direct-writing and displaying devices.

### SUMMARY OF THE INVENTION

In view of the above drawbacks, the present invention provides a writing and displaying device, which comprises: a display member comprising a first electric connecting portion and an exposed electrochromic layer electricly connected to the first electric connecting portion; an input member comprising a second electric connecting portion and an exposed electrolyte layer electricly connected to the second electric connecting portion; and a power supply member for supplying electric power to the input member and the display member, wherein when the electric power is supplied by the power supply member and the input member is in contact with the display member, the input member, the display member and the power supply member constitute a loop circuit such that electrochromism occurs to the portion of the display member in contact with the input member. Further, after the contact between the input member and the display member is removed, the electrochromism of the display member is maintained for a predetermined duration of time.

In particular, the power supply member electricly connects the first electric connecting portion and the second electric connecting portion, and the electrolyte layer of the input member is in contact with the electrochromic layer of the display member so as to constitute the loop circuit. The contact between the input member and the display member can be continuous or discontinuous. For example, the input member can be in continuous contact with the display member and move on the surface thereof so as to form a continuous trace (such as a character or a picture). The displayed characters, images, traces or pictures generated through the contact between the input member and the display member can be maintained for a certain duration of time due to a steady state persistence characteristic of the display member.

In an embodiment, the first electric connecting portion further comprises a first substrate and a first conductive layer formed on the first substrate, the electrochromic layer being formed on the first conductive layer such that the first conductive layer is sandwiched between the first substrate and the electrochromic layer; and the second electric connecting portion further comprises a second substrate and a second conductive layer formed on the second substrate, the electrolyte layer being formed on the second conductive layer such that the second conductive layer is sandwiched between the second substrate and the electrolyte layer. Accordingly, in the present embodiment, the power supply member electrically connects the first conductive layer and the second conductive layer.

The display member can have a flexible or non-flexible structure. The electrochromic layer of the display member comprises an electrochromic material having a steady state persistence characteristic. The electrochromic material is at least one selected from the groups consisting of a metal oxide, a transition metal cyanide complex and a conductive organic polymer, wherein the metal oxide is at least one selected from the groups consisting of tungsten oxide (WO₃), hydrated nickel oxide (NiOₓH_{y}), hydrated zinc oxide, molybdenum trioxide, vanadium pentoxide, TiO₂, CeO₂ and Nb₂O₅; the transition metal cyanide complex is at least one selected from the group consisting of iron hexacyanoferrate (Prussian blue), indium hexacyanoferrate (InHCF), copper hexacyanoferrate (CuHCF) and nickel hexacyanoferrate (NiHCF); and the conductive organic polymer is at least one selected from the group consisting of polyaniline (PANi), polypyrrole (PPy), poly(3,4-ethylenedioxythiophene) (PEDOT), polythiophene, bipyridiliums and viologens.

The electrolyte layer can be in a non-liquid, such as gel or solid form. In an embodiment, the electrolyte layer is gel.

In an embodiment, the electrolyte layer comprises an electrolytic material such as a lithium compound. The electrolytic material can further comprise an additive such as a polymer material for gelling the electrolyte layer. The polymer material can be, but not limited to, a light-permeable polymer material such as polymethylmethacrylate (PMMA), polycarbonate (PC) or polyethylene (PE).

In an embodiment, the first and second substrates may be made of the same or different materials, which may be flexible or non-flexible, and transparent or non-transparent according to the practical need. The first and/or second substrate may be made of, but not limited to, glass, plastic or ceramic.

The first conductive layer and the second conductive layer may be made of the same or different materials such as oxide composites (indium oxide, tin oxide, etc.), ferrous materials or magnetic materials. In addition, when a ferrous material or a magnetic material is used, it can serve as both the substrate and the conductive layer.

As for the display member, the first substrate is of a plate shape, the first conductive layer is disposed on the first substrate, and the electrochromic layer is disposed on the first conductive layer. According to the practical need, the display member may further comprise a first casing for receiving the first substrate, the first conductive layer and the electrochromic layer, or the first substrate may have a structure like a container for receiving the first conductive layer and the electrochromic layer, as long as the electrochromic layer is exposed from the display member.

As for the input member, the second conductive layer is disposed on the second substrate, and the electrolyte layer is disposed on the second conductive layer. According to the practical need, the display member may further comprise a second casing for receiving the second substrate, the second conductive layer and the electrolyte layer, or the second substrate may have a structure like a container for receiving the second conductive layer and the electrolyte layer, as long as the electrolyte layer is exposed from the input member.

According to another embodiment, the display member is of a plate shape, and the input member is of a pen shape so as to facilitate the user to hold the pen-shaped input member to write characters or symbols or draw pictures on the display member for instant display.

In an embodiment, the electrolyte layer of the input member can be prepared into a desired picture or symbol such that when the user holds the input member to perform an operation similar to stamping for making the input member in contact with the display member, the desired picture or symbol can be displayed through the display member.

The power supply member provides the electric power to the input member and the display member to allow an oxidation-reduction reaction to occur when the electrolyte layer of the input member is in contact with the electrochromic layer of the display member, thereby causing electrochromism and achieving a display effect. In an embodiment, the value of the electric power is determined according to the electrochromic material contained in the electrochromic layer. By switching the electric power between positive and negative, an effect of displaying/deleting the input information can be achieved.

In an embodiment, for example, when Prussian blue is used as an electrochromic material, the operating voltage of the electric power is between +3V and −2V. In particular, when the operating voltage of the electric power is positive and the electrolyte layer is in contact with the electrochromic layer containing Prussian blue, the electrochromic layer rapidly turns from blue to colorless, and the electrochromic layer can maintain colorless for several hours even after the voltage supply is turned off. On the other hand, when the operating voltage of the electric power is negative and the electrolyte layer is in contact with the electrochromic layer containing Prussian blue, the electrochromic layer rapidly turns from colorless to blue. As a result, an effect of displaying/deleting input messages can be achieved through the supply of the electric power and change of the color.

The present invention provides a novel structure of the electrochromic member so as to develop a direct-writing and displaying device that can be applied to electronic handwriting bulletin boards, electronic billboards, writing boards and so on.

The writing and displaying device according to the present invention can be driven by a low voltage for instant message display and has a steady-stage persistence characteristic so as to maintain the display effect even after the electric power is turned off. Meanwhile, since messages can be easily displayed or deleted, the writing and displaying device is reusable and environmentally friendly. Furthermore, the writing and displaying device according to the present invention has a low production cost and a simple structure, which result in easy fabrication and mass production.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a sectional view of a conventional electrochromic member;

FIG. 2 is a sectional view of a writing and displaying device according to a first embodiment of the present invention;

FIG. 3 is a schematic view of a writing and displaying device according to a second embodiment of the present invention;

FIG. 4 is a schematic view of a writing and displaying device according to a third embodiment of the present invention; and

FIG. 5 is a view showing the display result of a writing and displaying device according to the present invention.

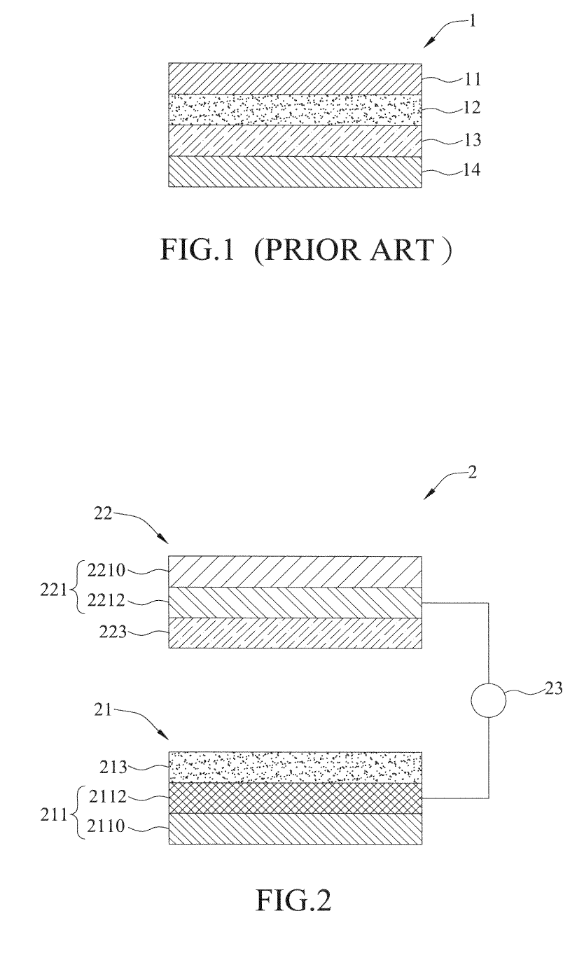

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification.

FIG. 2 shows a writing and displaying device according to a first embodiment of the present invention. Referring to FIG. 2, the writing and displaying device 2 comprises a display member 21, an input member 22 and a power supply member 23, wherein the display member 21 comprises a first electric connecting portion 211 and an electrochromic layer 213 electricly connected to the first electric connecting portion 211, and the first electric connecting portion 211 further comprises a first substrate 2110 and a first conductive layer 2112 formed on the first substrate 2110; the input member 22 comprises a second electric connecting portion 221 and an electrolyte layer 223 electricly connected to the second electric connecting portion 221, and the second electric connecting portion 221 further comprises a second substrate 2210 and a second conductive layer 2212 formed on the second substrate 2210.

When a suitable operating voltage is provided by the power supply member 23 and the electrolyte layer 223 is in contact with the electrochromic layer 213, an oxidation-reduction reaction occurs to the portion of the electrochromic layer 213 in contact with the electrolyte layer 223 so as to generate electrochromism, thereby achieving an effect of displaying a pattern in a local area of the display member. After the contact between the display member 21 and the input member 22 is removed and the voltage supply is turned off, the electrochromism of the display member 21 can still be maintained for several hours.

In the first embodiment, the first substrate 2110 is made of an insulating material such as glass, plastic or ceramic, which can be flexible or non-flexible, transparent or non-transparent. The first conductive layer 2112 is made of a conductive material such as an oxide composite (indium oxide or tin oxide) and has a thickness of 100 nm to 2 μm. The electrochromic layer 213 comprises an electrochromic material having a steady-state persistence characteristic, wherein the electrochromic material is selected from one of the group consisting of tungsten oxide (WO₃), hydrated nickel oxide, hydrated zinc oxide, molybdenum trioxide, vanadium pentoxide, TiO₂, CeO₂, Nb₂O₅, iron hexacyanoferrate (Prussian blue), indium hexacyanoferrate (InHCF), copper hexacyanoferrate (CuHCF), nickel hexacyanoferrate (NiHCF), polyaniline (PANi), polypyrrole (PPy), poly(3,4-ethylenedioxythiophene) (PEDOT), polythiophene, bipyridiliums and viologens. The electrochromic layer 213 has a thickness of 100 nm to 2 μm.

Referring to FIG. 2, the first conductive layer 2112 is disposed on the first substrate 2110, which can be directly formed on the insulating material of the first substrate or can be prepared first and then attached to the insulating material. In an embodiment, the first conductive layer 2112 can be directly formed on the first substrate 2110 by wet chemical coating or physical vapor deposition such as electroplating, sputtering and evaporating. In another embodiment, a film of the first conductive layer 2112 is formed of a conductive material first and then attached to the first substrate 2110. Further, an ITO conductive substrate can be used as the first conductive layer 2112 and the first substrate 2110. The electrochromic layer 213 is disposed on the first conductive layer 2112 and exposed from the display member 21. The electrochromic layer can be formed by, but not limited to, electroplating, sputtering, evaporating, layer stacking, or sol-gel.

In the first embodiment, the second substrate 2210 is made of such as glass, plastic or ceramic, which can be flexible or non-flexible, transparent or non-transparent according to the practical need. The second conductive layer 2212 is made of a conductive material such as an oxide composite (oxide indium or oxide tin). The electrolyte layer 223 comprises a lithium compound and a polymer material. Since material loss easily occurs in a liquid electrolyte layer, it makes it difficult for the user to control the contact path when the user writes or draws through the input member, and meanwhile shortens the lifetime of the input member. Therefore, the electrolyte layer can be made of a non-liquid material, which can be solid or gel. A gel electrolyte layer prevents the material loss, does not easily wear out or damage the electrochromic layer, and extends the lifetime of the device.

Referring to FIG. 2, the second conductive layer 2212 is disposed between the second substrate 2210 and the electrolyte layer 223. The second conductive layer 2212 can be directly formed on the second substrate 2210 by wet chemical coating or physical vapor deposition such as electroplating, sputtering and evaporating. Alternatively, a film of the second conductive layer 2212 is formed of a conductive material first and then attached to the second substrate 2210. Further, a ferrous material or magnetic material can be used as the second substrate 2210 and the second conductive layer 2212.

In an embodiment, the electrolyte layer 223 is partially packaged or embedded in the second conductive layer 2212 and the second substrate 2210 (referred as conductive substrate), and at least one surface thereof is exposed. In another embodiment, the conductive substrate is of a shape of a hollow container so as to receive the electrolyte layer 223, at least one surface of the electrolyte layer 223 being exposed from the conductive substrate.

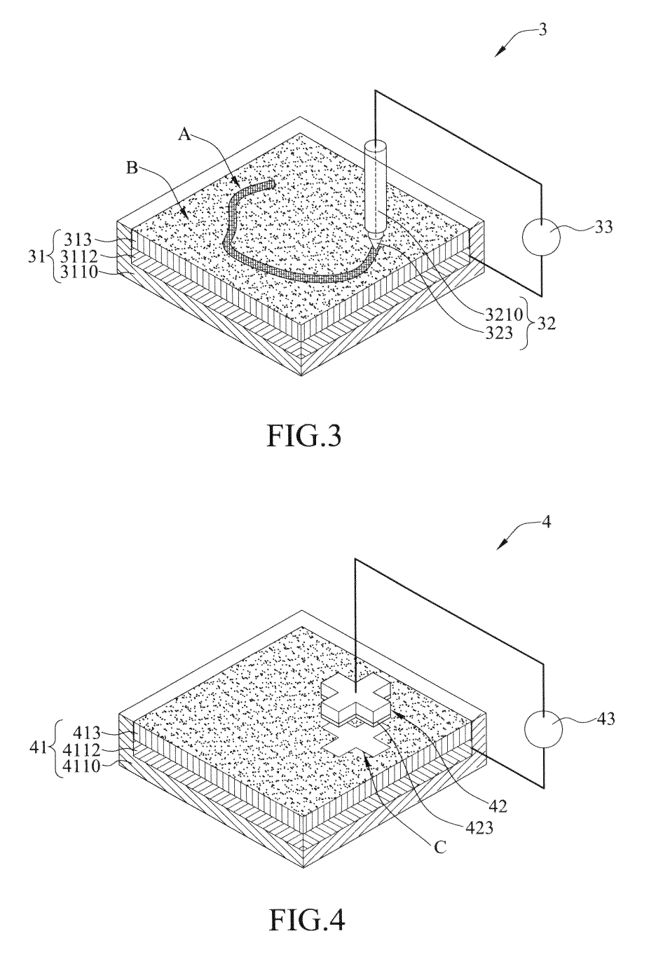

FIG. 3 shows a writing and displaying device according to a second embodiment of the present invention. Referring to FIG. 3, the writing and displaying device 3 comprises a display member 31, an input member 32 and a power supply member 33. An electrochromic layer 313 is formed on a first substrate 3110 and a first conductive layer 3112 (an ITO conductive substrate can be used to serve as both the substrate and the conductive layer) and constitutes the display member 31. The input member 32 is made of a pen shape, wherein a second substrate 3210 constitutes the body of the pen, and an electrolyte layer 323 constitutes the tip of the pen.

When the operating voltage is applied by the power supply member 33, the user can hold the pen-shaped input member 32 to write or draw on the display member 31. Along the continuous or discontinuous trace of the input member 32, the electrochromism occurs to the portion of the electrochromic layer 313 in contact with the input member 32 due to an oxidation-reduction reaction, thereby resulting in a color difference between the trace A and the background B and achieving an effect of displaying the input information (characters or pictures).

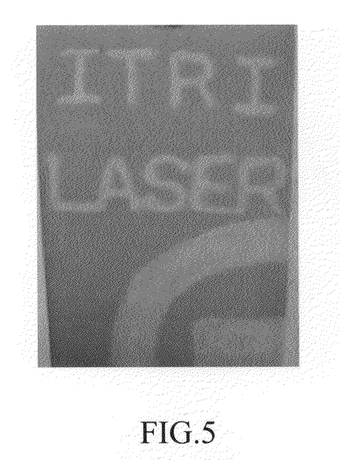

FIG. 4 shows a writing and displaying device according to a third embodiment of the present invention. The writing and displaying device 4 comprises a display member 41, an input member 42 and a power supply member 43. An electrochromic layer 413 is formed on a first substrate 4110 and a first conductive layer 4112 (an ITO conductive substrate can be used) and constitutes the display member 41. An electrolyte layer 423 of the input member 42 can be prepared into a contours with a desired pattern(s) such as English alphabets, totems, symbols and so on. The writing and displaying device 4 can comprise a plurality of input members 42 of different contours such as a pen shape as described in the second embodiment.

When the operating voltage is provided by the power supply member 43, the user holds the input member 42 to perform an operation similar to stamping for making the input member 42 in contact with the display member 41 such that an electrochromism occurs to the portion of the electrochromic layer 413 in contact with the input member 42 because of an oxidation-reduction reaction, thereby generating a pattern C and achieving an effect of displaying the input information, namely the contour of the electrolyte layer 423.

### An Instance of the Embodiment

The preparation of an electroplating solution of Prussian blue: 200 g of deionized water, 1.6 g of potassium hexacyanoferrate (III), 0.8 g of ferric chloride hexahydrate, and 1.74 g of potassium bisulfate are mixed, vibrated by an ultrasonic vibrator, stirred for 30 minutes at a rotation speed of 500 rpm and left static for powder deposition and then the powder is removed.

The ITO conductive substrate is placed in the electroplating solution and electroplated for 10 minutes at an operating voltage of 1V, thereby forming a Prussian blue electrochromic film on the ITO conductive substrate with a thickness of 100 nm to 2 μm. The ITO conductive substrate with the Prussian blue electrochromic film constitutes the display member.

The preparation of an electrolytic material: 5 g of polymethylmethacrylate (PMMA) powder is added into 80 g of liquid tetrahydrofuran, vibrated by an ultrasonic vibrator for 10 minutes, and placed in an oven to bake at 65° C. until the powder is completely dissolved, thereafter, 1 g of lithium perchlorate powder is added thereto, vibrated and baked as described above until the powder is completely dissolved, thereafter, 4 g of ethylene carbonate and 7 g of propylene carbonate are added, vibrated and baked as described above until the solvent evaporates, thereby obtaining a gel electrolytic material.

The prepared gel electrolytic material is then poured onto an ITO conductive substrate to form a gel electrolytic film. The ITO conductive substrate with the gel electrolytic film constitutes an input member.

The electric power of certain value is provided between the above-described display member and the input member so as to constitute a loop circuit. According to the characteristic of Prussian blue, when the operating voltage of +3V is provided, the material turns into colorless, otherwise, when the operating voltage of −2V is provided, the material turns back to the original color of blue. FIG. 5 shows a display result of such a device, wherein the original background of the display member is blue, after the user writes on it through an input member, transparent letters of ‘ITRI LASER,’ a transparent arc line and a transparent rectangle are formed. The bottom of the substrate has a color of white to facilitate observation of the result. Further, the Prussian blue has a steady state persistence characteristic, which allows the colorless state to be maintained for 6 to 8 hours after the voltage supply is turned off.

The above-described descriptions of the detailed embodiments are only to illustrate the implementation according to the present invention, and it is not to limit the scope of the present invention, Accordingly, all modifications and variations completed by those with ordinary skill in the art should fall within the scope of present invention defined by the appended claims.

What is claimed is:

1. A writing and displaying device, comprising:
a display member comprising a first electric connecting portion and an electrochromic layer electrically connected to the first electric connecting portion and exposed from the display member;
an input member comprising a second electric connecting portion and an exposed electrolyte layer electricly connected to the second electric connecting portion; and
a power supply member for supplying electric power to the input member and the display member,
wherein when the electric power is supplied by the power supply member and the input member is in contact with the display member, the input member, the display member and the power supply member constitute a loop circuit such that electrochromism occurs to a portion of the display member in contact with the input member.

2. The device of claim 1, wherein the electrolyte layer of the input member is in contact with the electrochromic layer of the display member so as to constitute the loop circuit.

3. The device of claim 1, wherein the first electric connecting portion further comprises a first substrate and a first conductive layer formed on the first substrate, the electrochromic layer being formed on the first conductive layer such that the first conductive layer is sandwiched between the first substrate and the electrochromic layer.

4. The device of claim 3, wherein the second electric connecting portion further comprises a second substrate and a second conductive layer formed on the second substrate, the electrolyte layer being formed on the second conductive layer such that the second conductive layer is sandwiched between the second substrate and the electrolyte layer.

5. The device of claim 1, wherein the power supply member electricly connects the first electric connecting portion and the second electric connecting portion.

6. The device of claim 4, wherein the power supply member electricly connects the first conductive layer and the second conductive layer.

7. The device of claim 1, wherein the electrochromic layer comprises an electrochromic material having a steady state persistence characteristic.

8. The device of claim 7, wherein the electrochromic material is at least one selected from the groups consisting of a metal oxide, a transition metal cyanide complex and a conductive organic polymer.

9. The device of claim 8, wherein the metal oxide is at least one selected from the groups consisting of tungsten oxide (WO₃), hydrated nickel oxide, hydrated zinc oxide, molybdenum trioxide, vanadium pentoxide, TiO₂, CeO₂ and Nb₂O₅.

10. The device of claim 8, wherein the transition metal cyanide complex is at least one selected from the group consisting of iron hexacyanoferrate, indium hexacyanoferrate (InHCF), copper hexacyanoferrate (CuHCF) and nickel hexacyanoferrate (NiHCF).

11. The device of claim 8, wherein the conductive organic polymer is at least one selected from the group consisting of polyaniline (PANi), polypyrrole (PPy), poly(3,4-ethylenedioxythiophene) (PEDOT), polythiophene, bipyridiliums and viologens.

12. The device of claim 1, wherein the electrolyte layer comprises a lithium compound.

13. The device of claim 1, wherein the electrolyte layer is gel or solid.

14. The device of claim 12, wherein the electrolyte layer further comprises a polymer material.

15. The device of claim 14, wherein the polymer material is at least one selected from the groups consisting of polymethylmethacrylate (PMMA), polycarbonate (PC) and polyethylene (PE).
